(19) United States
(12) Patent Application Publication
(10) Pub. No.: US 2014/0117752 A1
(43) Pub. Date: May 1, 2014

(54) PILOT SIGNAL FILTER

(71) Applicants: Albert FLACK, Lake Arrowhead, CA (US); Nopakorn HIRANRAT, Walnut, CA (US)

(72) Inventors: Albert FLACK, Lake Arrowhead, CA (US); Nopakorn HIRANRAT, Walnut, CA (US)

(21) Appl. No.: 13/983,275

(22) PCT Filed: Feb. 1, 2012
(86) PCT No.: PCT/US12/23487

§ 371 Date: Jan. 13, 2014

Related U.S. Application Data
(60) Provisional application No. 61/438,487, filed on Feb. 1, 2011.

(51) Int. Cl. B60R 16/023

(52) U.S. Cl. CPC B60R 16/023
USPC 307/9.1

(57) ABSTRACT

In various implementations, method is provided for reducing noise in a pilot signal, which may include sampling the pilot signal and creating a first data set comprising the samples of the pilot signal samples. It may also include selecting a first subset from the first data set and averaging the first subset to produce a first tier averaged output of the selected first subset. It may further include creating a second data set of the first tier averaged outputs and selecting a second subset from the second data set and averaging the second subset to produce the pilot signal output. In various embodiments, this method may further include, or separately include generating the pilot signal with a modulation rate within an allowable range and offset from a central modulation rate of the allowable range.

### CROSS-REFERENCE TO RELATED APPLICATION

The present application claims the benefit of U.S. Provisional Application 61/438,487 entitled PILOT SIGNAL FILTER, by Flack et al, filed Feb. 1, 2011, hereby incorporated by reference in its entirety.

The present application is a continuation-in-part of PCT Application No. PCT/US2011/032579, filed 14 Apr. 2011, by Flack, entitled PILOT SIGNAL GENERATION CIRCUIT, herein incorporated by reference in its entirety, which claims the benefit of U.S. Provisional Application 61/324,293 filed Apr. 14, 2010, by Flack, entitled PILOT SIGNAL GENERATION CIRCUIT, herein incorporated by reference in its entirety.

### BACKGROUND

Electric vehicle supply equipment must comply with requisite safety and compliance standards to be deemed fit for public use and commercial sale. In particular, national UL regulations necessitate that all electronic devices pass inspections from nationally certified testing laboratories. These inspections include a conducted noise test in which signal noise is passed throughout the system, which is monitored to ensure that the generated noise is attenuated to a minimum.

The pilot circuit is a high impedance circuit with a +/−12V source and a 1 k ohm resistor in series with a 25 ft line to an electric vehicle. Along the line to the vehicle, the pilot signal line is parallel to the power lines, so any noise on the power lines tends to couple to the pilot signal line. This creates noise on the pilot signal in a range anywhere from a few Hz to GHz.

A conducted and radiated susceptibility test typically includes a broadcast at 80 MHz-1 GHz and wiring inserted noise between 400 KHz-80 MHz. A conventional solution for diminishing noise sufficiently to pass the SAE J1772 standard conducted and radiated susceptibility test is the inclusion of ferrite beads or rings which act as passive low-pass filters to reflect or absorb high-frequency signals. The inclusion of multiple ferrite rings or toroids, however, increases material and manufacturing costs as well as the increases the weight of the product and the resulting shipping costs.

What is needed is a more cost effective means to reduce noise on the pilot signal. Further what is needed is a means that supports and enhances the application of the SAE J-1772 standard for reading the communication level control voltages without noise induced errors.

### SUMMARY

In various implementations, a method is provided for reducing noise in a pilot signal output to an electric vehicle, which may include sampling the generated pilot signal and creating a first data set comprising the samples of the generated pilot signal. It may also include selecting a first subset from the first data set and averaging the first subset to produce a first tier averaged output of the selected first subset. It may further include creating a second data set of the first tier averaged outputs and selecting a second subset from the second data set and averaging the first tier averages of the second subset to determine the pilot signal value.

In various implementations, a method is provided for reducing noise in a pilot signal output to an electric vehicle, which may further include, or separately include generating the pilot signal with a modulation rate within an allowable range and offset from a central modulation rate of the allowable range.

### BRIEF DESCRIPTION OF THE DRAWINGS

The features and advantages of the present invention will be better understood with regard to the following description, appended claims, and accompanying drawings where:

FIG. 1 is a simplified block diagram of an implementation for reducing high signal noise in Electric Vehicle Supply Equipment (EVSE).

FIG. 1A is a simplified line graph showing the pilot signal rate range.

FIG. 1B is a simplified line graph showing the pilot signal rate range.

FIG. 2 is a simplified flow chart of one possible implementation of a method for reducing noise in a pilot signal output to an electric vehicle.

FIG. 3 is a simplified block diagram of an electric vehicle supply equipment or EVSE.

FIG. 4 shows a circuit diagram of one possible embodiment of the pilot generator and detector of FIG. 3.

FIG. 5 shows a schematic view of a cable to connect utility power to an electric vehicle (not shown) along with some associated circuitry.

FIG. 6 shows an enlarged view schematic drawing of the GFI circuit of FIG. 5.

FIG. 7 shows a schematic view of a contactor control circuit.

FIG. 8 shows an enlarged more complete schematic of the pilot circuitry shown in partial schematic in FIG. 5.

FIG. 9 is a partial schematic showing a microprocessor, which may be used to govern the output of the GFI circuit and/or the pilot signal circuit.

FIG. 10 shows a simplified plot of an example of possible charge accumulation by the double stage filter leading to a fault detection by the comparator.

FIG. 11 is a simplified schematic diagram of a pilot signal generation circuit in accordance with one possible embodiment.

FIG. 12 is an example timing diagram of signals for the pilot circuit of FIG. 11.

### DESCRIPTION

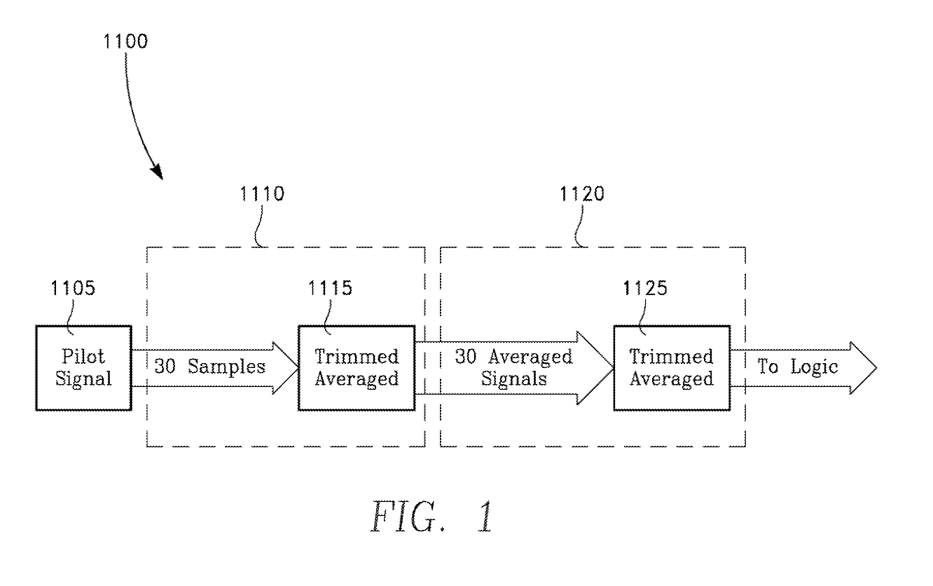

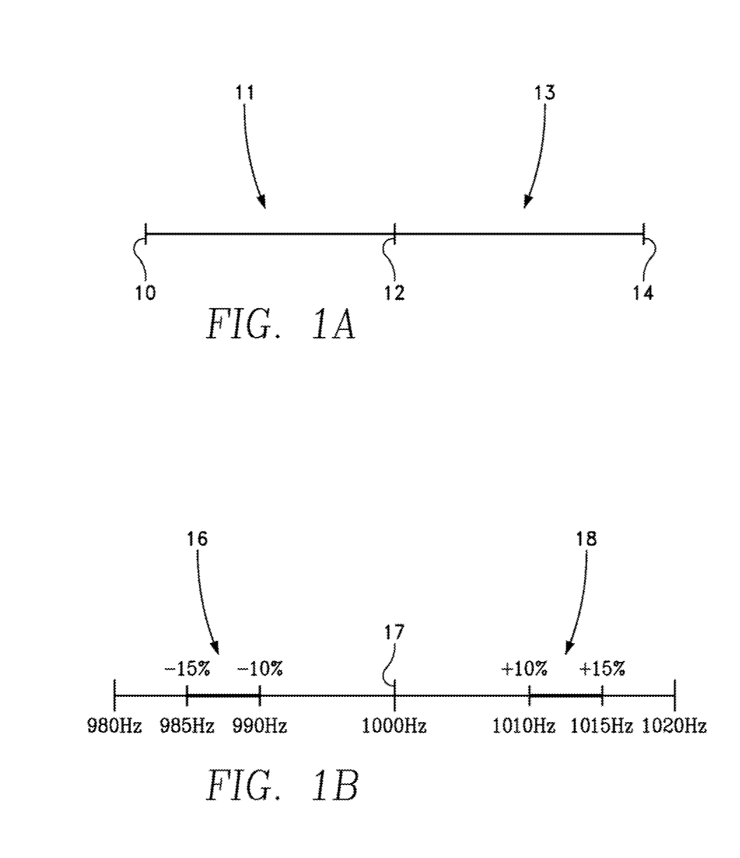

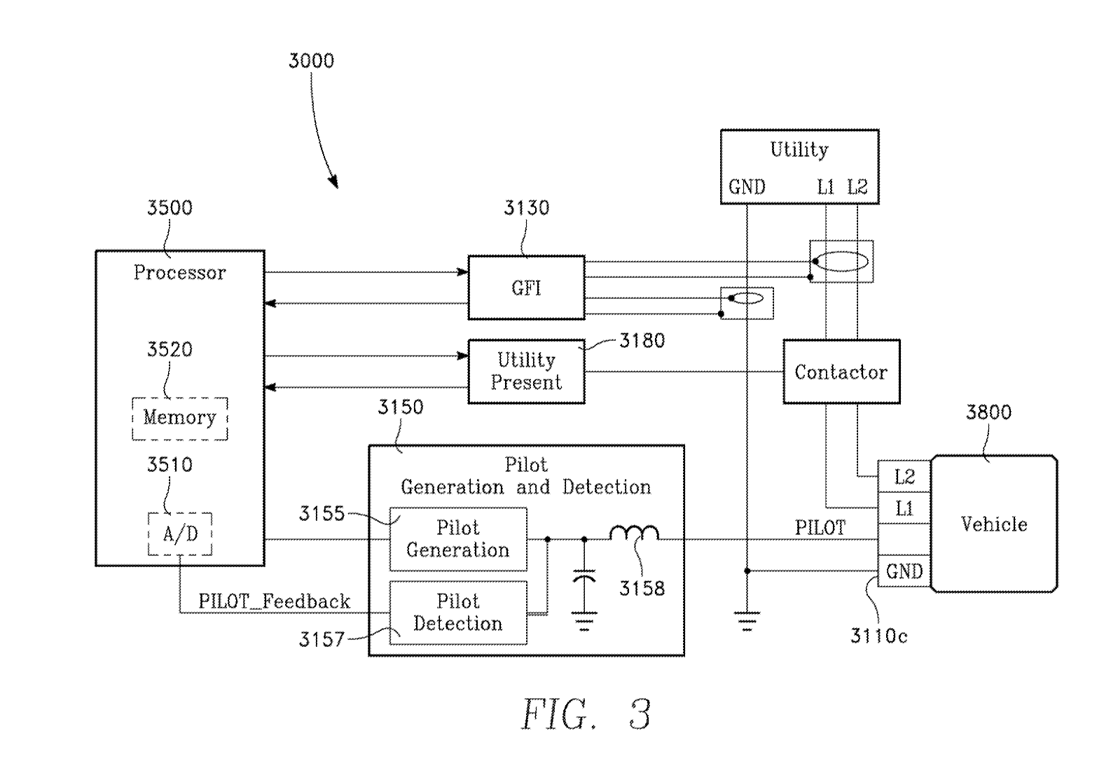

FIG. 1 is a simplified block diagram of an implementation for reducing high signal noise in the pilot signal detected by an electric vehicle supply equipment or EVSE 3000 (FIG. 3). Shown in FIG. 1 is a two-tiered filtering method 1100. The first tier filter 1110 compiles 30 samples of the EVSE pilot signal 1105, taken at one sample every millisecond. A subset of the samples may be selected by trimming the samples. A first tier average is generated at 1115 from the subset of trimmed samples. Thus, in one implementation the first tier average is generated by eliminating the two highest and two lowest values from the 30 samples and generating an average of the remaining 26 to produce a single first tier average output value from the trimmed samples. The second tier filter 1120 receives as its input the first tier average signals generated at 1115. The second tier filter 1120 generates a second tier average at 1125 from a subset of the first tier averages. Thus, the second tier filter 1120 generates an average at 1125 from a set of 30 first tier averages by eliminating the two highest and two lowest first tier average values and then averaging the 26 remaining first tier average values. The resultant second tier average signals at 1125 may then be utilized by the logic systems (software and hardware) of the electric vehicle service equipment 3000 (FIG. 3).

In some implementations, the two-tier filter is implemented in software, such as with a processor 3500 (FIG. 3). Thus, in various implementations, the pilot signal filter software removes the need for additional physical filters such as ferrite rings, which saves on material and installation costs as well as conserves space within the service equipment apparatus.

For example, referring to FIG. 3, the present inventors have found that in one implementation, the above two-tiered pilot signal filter allowed a reduction of the number of toroidal ferrite filters 3158 in the pilot generation and detection circuitry 3150 from 4 toroids (approximately 3″ diameter) down to 1 toroid filter 3158 of the same diameter.

In addition, because taking too many readings can slow down the response of the EVSE 3000, the above discussed selected sample size of averaged readings are chosen to ensure filter efficacy both in reducing the effects of signal noise, and ensuring that the overall sampling rate provides reasonable response times, so as to provide compliance with the SAE J1772 standard. The pilot signal is typically a 1000 Hz modulated signal, so the above discussed sample rate for the two tiered filter ensures a response time of about 900 ms.

Further, in some implementations, the modulation rate of the pilot signal is selected to be offset from the 1000 Hz modulation rate so as to reduce the effects of noise centered at 1000 Hz. Thus, referring to FIG. 1A, in some implementations, the modulation rate of the pilot signal may be selected to be a value at 11 or 13 which is other than 1000 Hz, at 12, but within the 980-1020 Hz range (10 to 14) allowed by the SAE J1772 standard. For example, referring to FIG. 1B, a modulation rate of 1015 Hz shown at 15 may be selected so that the effects of introduced noise centered at 1000 Hz are reduced. In some embodiments, the modulation rate may be at +/−10% to 15% away shown at 16 and 18, respectively, from the center modulation rate shown at 17.

In this implementation, the pilot signal modulation should selected as far away from the center modulation as possible, but within the given precision/tolerance of the modulation circuitry, so as to ensure that the modulation will remain within the allowable range.

The offset pilot signal further improves the results of the two-tiered signal filter discussed herein to provide improved detection accuracy of pilot signals having 150 KHz to 1 GHz induced noise at a 1 kHz rate. The offset pilot signal may be used with or without the two-tiered signal filter discussed herein, or with other software and/or hardware filtering.

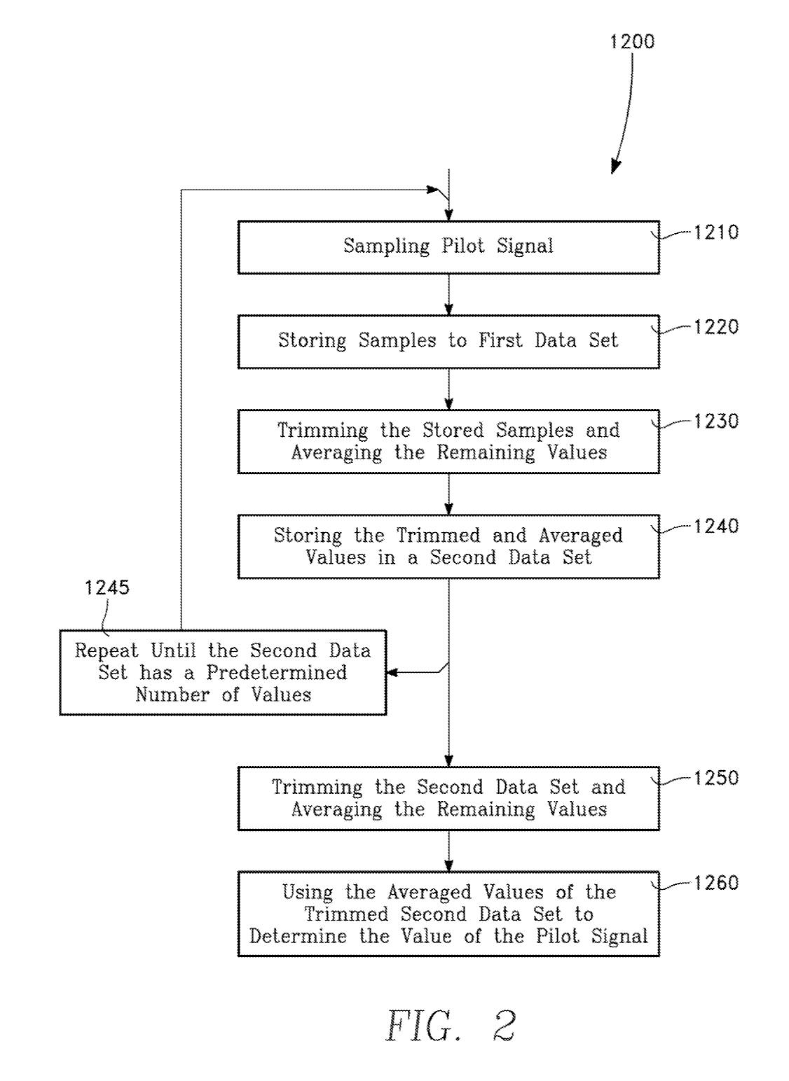

FIG. 2 is a simplified flow chart of one possible implementation 1200 of a method for reducing noise in a pilot signal output/detected to/from an electric vehicle 3800 (FIG. 3). The pilot signal is sampled 1210, and the samples are stored 1220 as a first data set. The stored samples of the first data set are trimmed and the remaining values of the first data set are averaged 1230. Several trimmed and averaged 1230 values from the first data set are stored 1240 to create a second data set. The second data set is created by repeating 1245 the steps of sampling 1210, storing 1220 the samples to the first data set, trimming and averaging 1230 the first data set, and storing to the second data set until the second data set has a sufficient amount of values. Thereafter, the second data set is trimmed and the remaining values of the second data set are averaged 1250. The averaged value of the trimmed second data set may be used 1260 as the detected value of the pilot signal, such as by a system processor for example, and thus may be used for controlling power delivery at the power delivery output of the electric vehicle supply equipment.

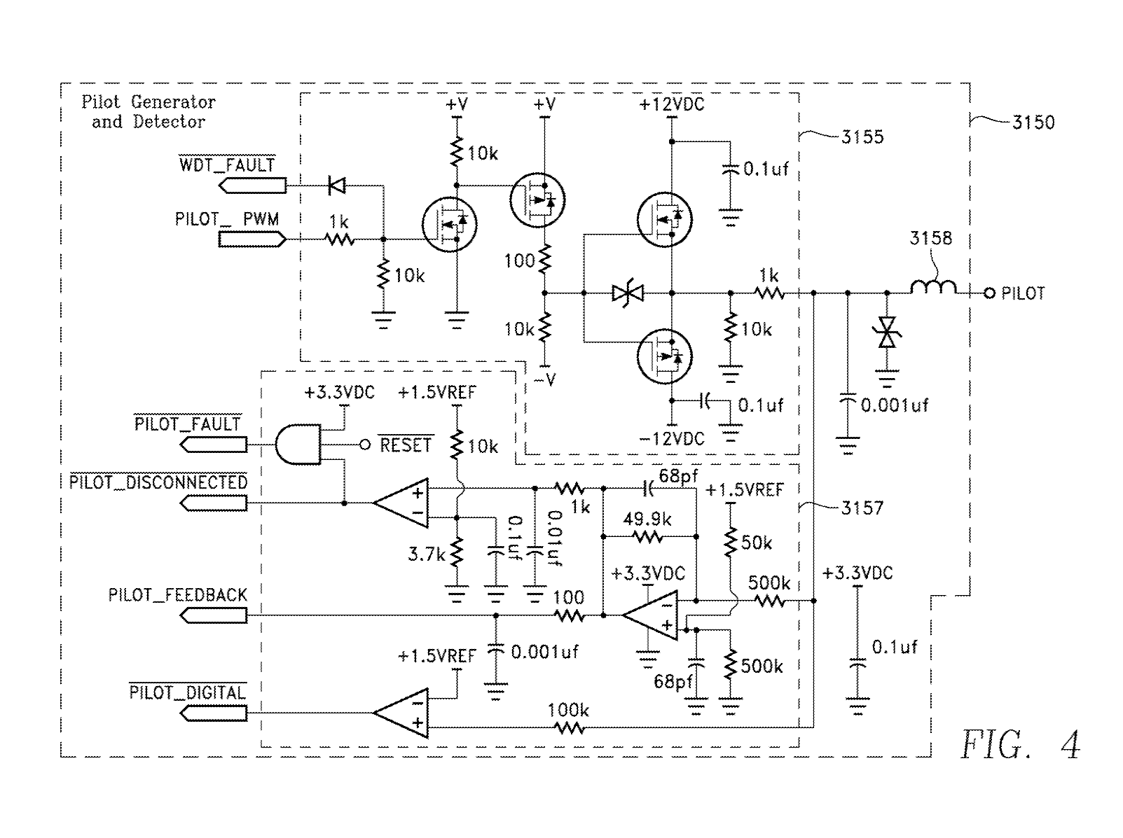

FIG. 3 shows a simplified block diagram of an electric vehicle supply equipment 3000 or EVSE. FIG. 4 shows a circuit diagram of one possible embodiment of the pilot generator and detector 3150 of FIG. 3. Referring to FIGS. 3 and 4, the EVSE 3000 may include a pilot signal sampler, which in some embodiments may include the pilot signal detector 3157 and the A/D converter 3510. In other embodiments not shown, a standalone A/D converter may sense the PILOT signal at the power delivery output 3110c and provide samples to the processor 3500, if desired.

In the embodiment shown, however, the processor 3500 samples the PILOT_FEEDBACK signal with an A/D converter 3510 and generates samples of the PILOT signal using PILOT_FEEDBACK signal supplied by the pilot signal detector 3157. As the PILOT signal to the vehicle ranges from +12 volts to −12 volts, a pilot detector circuit 3157 within the pilot generation and detection circuit 3150 detects the PILOT signal and reduces it to logic level signals for distribution to the A/D converter 3150. For example, the sensed PILOT signal may be reduced from a range of +12 volts to −12 volts to a range of 0.3 volts to 2.7 volts, correspondingly. The logic level PILOT_FEEDBACK signal is provided to the A/D converter 3150 input of the processor 3500 for storing into memory 3520.

The samples may be stored to a processor readable medium such as an addressable memory 3520, for example RAM. In various embodiments, either one or both of the A/D converter 3510 and the memory 3520 may be external to, or onboard the processor 3500. The processor 3500 of FIG. 3 is programmed to determine a signal level of the PILOT signal output to an electric vehicle 3800 based on the samples of the PILOT_FEEDBACK signal.

The processor 3500 may include a processor executable instructions for carrying out the steps of trimming and averaging a first data set of stored pilot signal samples. The trimmed average of the first data set are stored in a second data set by repeating the step of storing samples to the first data set, trimming the first data set, and averaging the first data set so as to create the second data set. The instructions further include trimming the second data set and generating an average from the trimmed samples of the second data set and using the average of the trimmed second data set in controlling power delivery at the power delivery output 3110c of the electric vehicle supply equipment 3000.

The amount of samples and the size of the subsets selected, can vary depending on the embodiment. Thus, the number and location (highest or/and lowest values) of samples and/or first tier averages that are trimmed can vary depending on the embodiment.

One example of a possible pilot signal generation circuit embodiment, which may be used in conjunction with, or be a part of, various implementations or embodiments is disclosed below, and in PCT Application No. PCT/US2011/032579, filed 14 Apr. 2011, by Flack, entitled PILOT SIGNAL GENERATION CIRCUIT, herein incorporated by reference in its entirety, which claims the benefit of U.S. Provisional Application 61/324,293 filed Apr. 14, 2010, by Flack, entitled PILOT SIGNAL GENERATION CIRCUIT, disclosed below and herein incorporated by reference in its entirety.

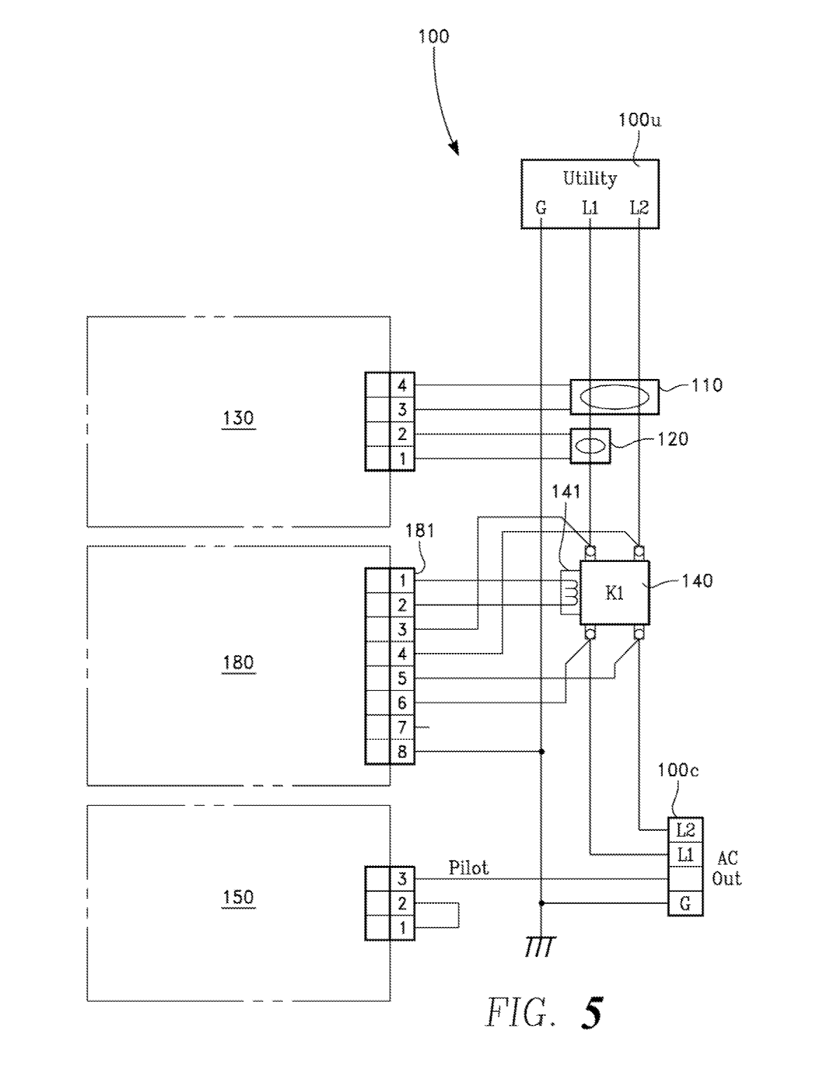

FIG. 5 shows a schematic view of a cable 100 to connect utility power to an electric vehicle (not shown) along with some associated circuitry. In the embodiment of FIG. 5, the cable 100 contains L1 and L2 and ground G lines. The cable 100 connects to utility power at one end 100u and to an electric vehicle (not shown) at the other end 100c. The electric vehicle (not shown) could have an onboard charger, or, the electric vehicle end 100c of the cable 100 could be connected to a separate, optionally free standing, charger (not shown). The separate charger (not shown) would in turn be connected to the electric vehicle for charging onboard batteries, or other charge storage devices. In other embodiments not shown, a charger could be integrated into the cable 100, if desired.

The cable 100 contains current transformers 110 and 120. The current transformer 110 is connected to a ground fault interrupt or GFI circuit 130 which is configured to detect a differential current in the lines L1 and L2 and indicate when a ground fault is detected. Contactor 140 may be open circuited in response to a detected ground fault to interrupt utility power from flowing on lines L1 and L2 to the vehicle (not shown).

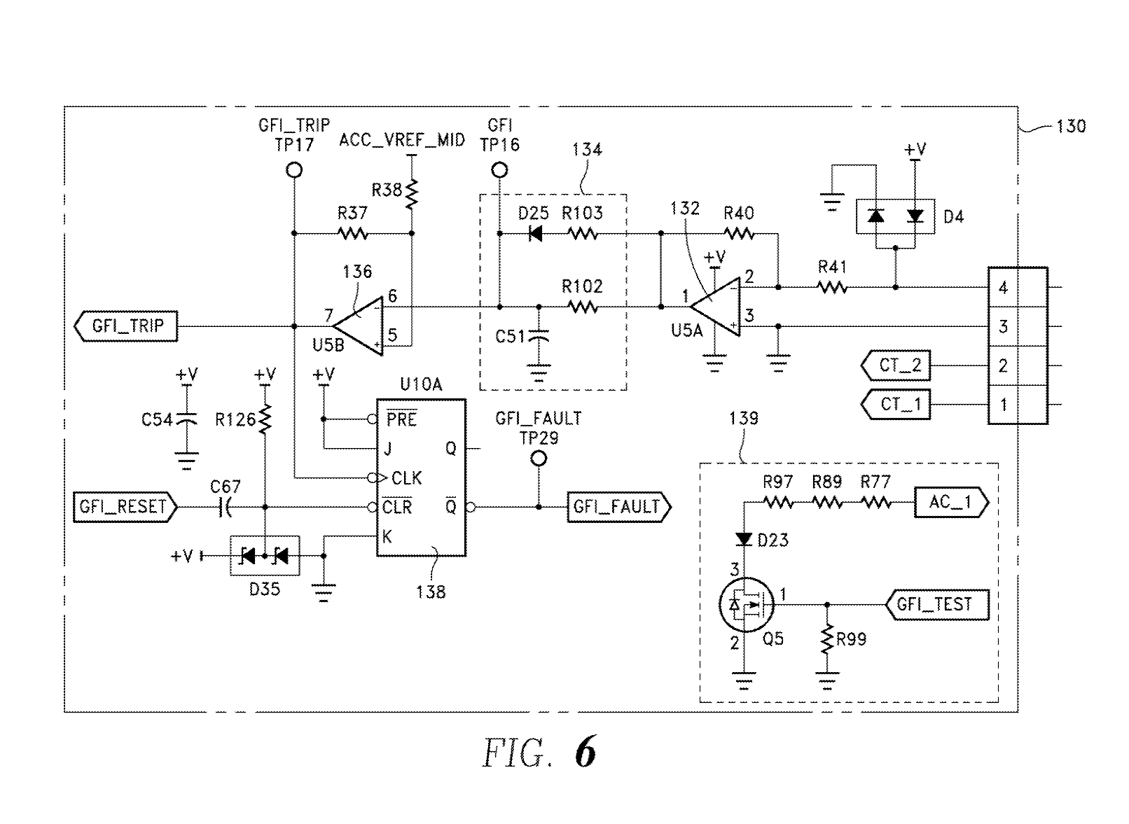

FIG. 6 shows an enlarged view schematic drawing of the GFI circuit 130 of FIG. 5. In the embodiment of FIG. 6, the GFI circuit 130 is designed to trip in the 5-20 mA range for GFI in accordance with the UL 2231 standard.

A signal provided by current transformer 110 (FIG. 6) at pins 3 and 4 of the GFI circuit 130 is amplified by op amp 132 to a voltage reference. That voltage reference is filtered by a double stage RC filter 134 to eliminate spurious noise spikes.

Fault current detected by current transformer 110 (FIG. 5) is converted to voltage by gain amplifier 134 for comparison by comparator 136. The output of the gain amplifier 132 is filtered prior to being supplied to the comparator 136 with the double stage RC filter 134 to remove spurious noise that could cause nuisance shut downs. Output of comparator 136 is latched with flip-flop 138 so that contactor 140 (FIG. 5) does not close after a fault has been detected. The comparator 136 provides a GFI_TRIP signal output, which is an input to the fault latch 138 to produce a latched GFI_FAULT signal.

The double stage filter 134 provides a delay so that the shut-off circuit does not immediately shut off if a fault is detected. The double stage filter 134 is a half-wave rectified circuit that allows an incoming pulse width that is less than 50% in some embodiments, or even as small as about 38% in some embodiments, to accumulate over time so that it will charge at a faster rate than it discharges. The double stage filter 134 accumulates charge and acts an energy integrator. Thus, the GFI circuit 130 waits a time period before causing shut down. This is because it is not desirable to have an instantaneous shut down that can be triggered by noise in the lines L1 or L2, or in the GFI circuit 130. The GFI circuit 130 should trip only if a spike has some predetermined duration. In the embodiment shown, that duration is one to two cycles.

The filter 134 charges through R102 and R103. When it discharges, it only discharges through R102, so it charges more current than it discharges over time. The double stage filter 134 is a half wave rectified circuit due to diode D25.

Diodes D4 provide surge suppression protection. In typical embodiments, the gain amplifier 132 may actually have surge suppression protection. Despite this, diodes D4 are added to provide external redundant protection to avoid any damage to the gain amplifier 132. This redundant protection is significant, because if the 132 gain amplifier is damaged, the GFI protection circuit 130 may not function, resulting in inadequate GFI protection for the system. For example, without the redundant surge suppressing diodes D4, if a power surge were to damage the gain amplifier 132 so that it no longer provided output, the GFI circuit 130 would no longer be able to detect faults. Since UL 2231 allows utility power L1 and L2 power to be reconnected after a GFI circuit detects a ground fault surge, utility power L1 and L2 could conceivably be reconnected after the gain amplifier 132 had been damaged. It is significant to note that the diodes D4 are connected to the upper and lower reference voltage busses of the circuit, i.e. ground and 3 volts, respectively, so that they can easily dissipate surge current without causing damage to the circuitry. Thus, the redundant surge suppression diodes D4 provide an additional safety feature for the GFI protection circuit 130.

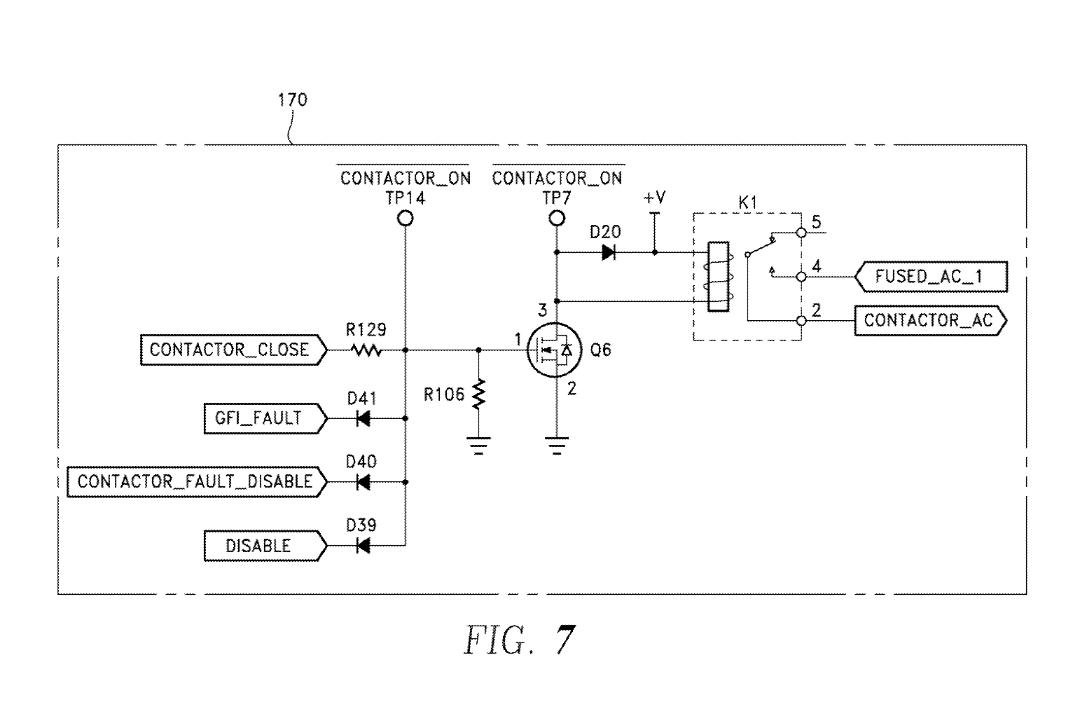

FIG. 7 shows a schematic view of a contactor control circuit 170. The contactor control circuit 170 opens/closes the contactor 140 (FIG. 5) to disconnect/connect the utility power L1 and L2 from/to the vehicle connector 100c. As discussed above with reference to FIG. 6, the GFI_TRIP signal is output by the comparator 136 and is an input to the fault latch 138 to produce the GFI_FAULT signal. The GFI_FAULT signal output by the fault latch 138 is an input to the contactor control circuitry 170, shown in FIG. 7, used to control the contactor control relay K1. The contactor control relay K1 is used to open/close the contactor 140 (FIG. 5) to disconnect/connect the utility power L1 and L2 from/to the vehicle connector 100c. The CONTACTOR_AC signal output by the contactor control relay K1 is connected to the contactor coil 141 (FIG. 5) through pin 1 of the connector 181 (FIG. 5) associated with the utility present circuitry 180 (FIG. 5).

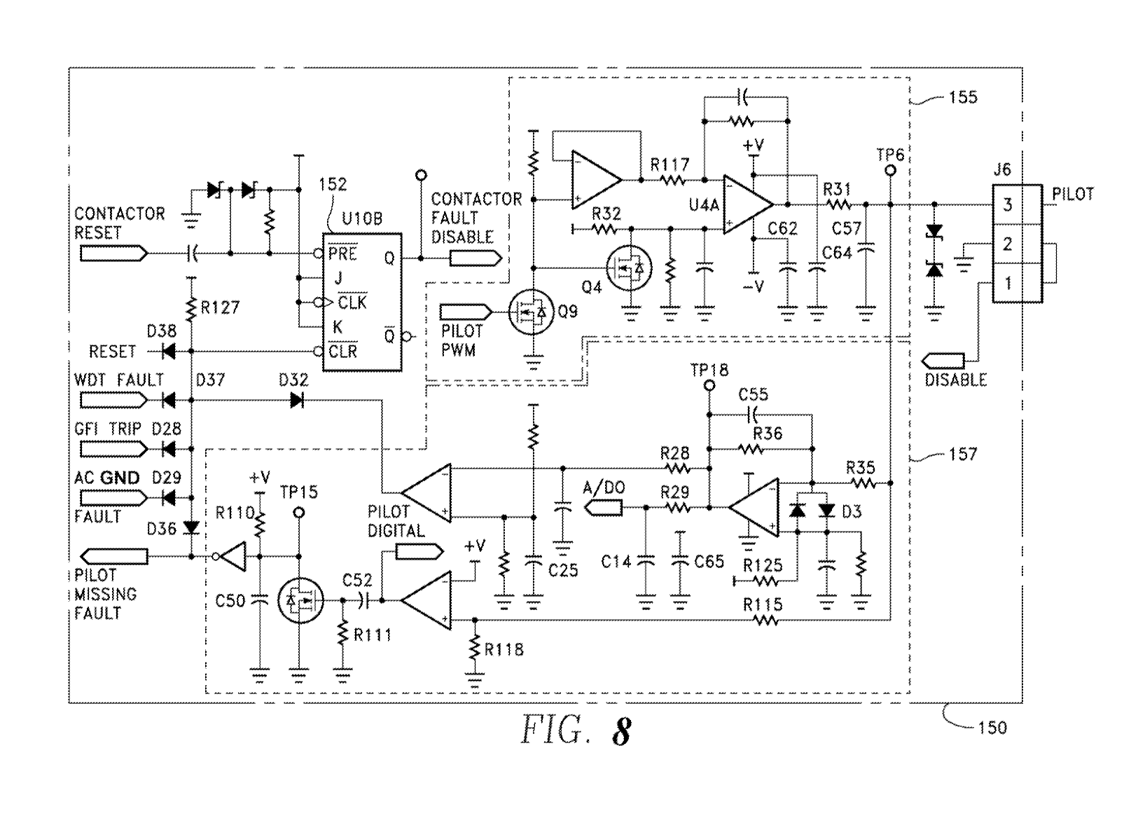

The GFI_TRIP signal output by the comparator 136 (FIG. 6) is not only provided to the contactor control circuit 170 (FIG. 7), but also is provided as an input to the contactor disable latch 152, shown in FIG. 8 to produce a CONTACTOR_FAULT_DISABLE signal. FIG. 8 shows an enlarged more complete schematic view of the pilot circuitry 150 shown in partial schematic in FIG. 5. Additionally, the contactor disable latch 152 (FIG. 8) is an input to the contactor control circuitry 170 (FIG. 8) to control the contactor control relay K1 (FIG. 7). The CONTACTOR_FAULT_DISABLE signal is used to open the contactor control relay K1 (FIG. 7), which opens the contactor 140 (FIG. 5) to open/close circuit the utility power L1 and L2. This provides a redundant circuit for this important safety control circuit. Further, it requires the reset of both latches 138 (FIG. 6) and 152 (FIG. 8) to reconnect L1 and L2 utility power to the vehicle connector 100c. This provides further software redundancy for this important safety control circuit.

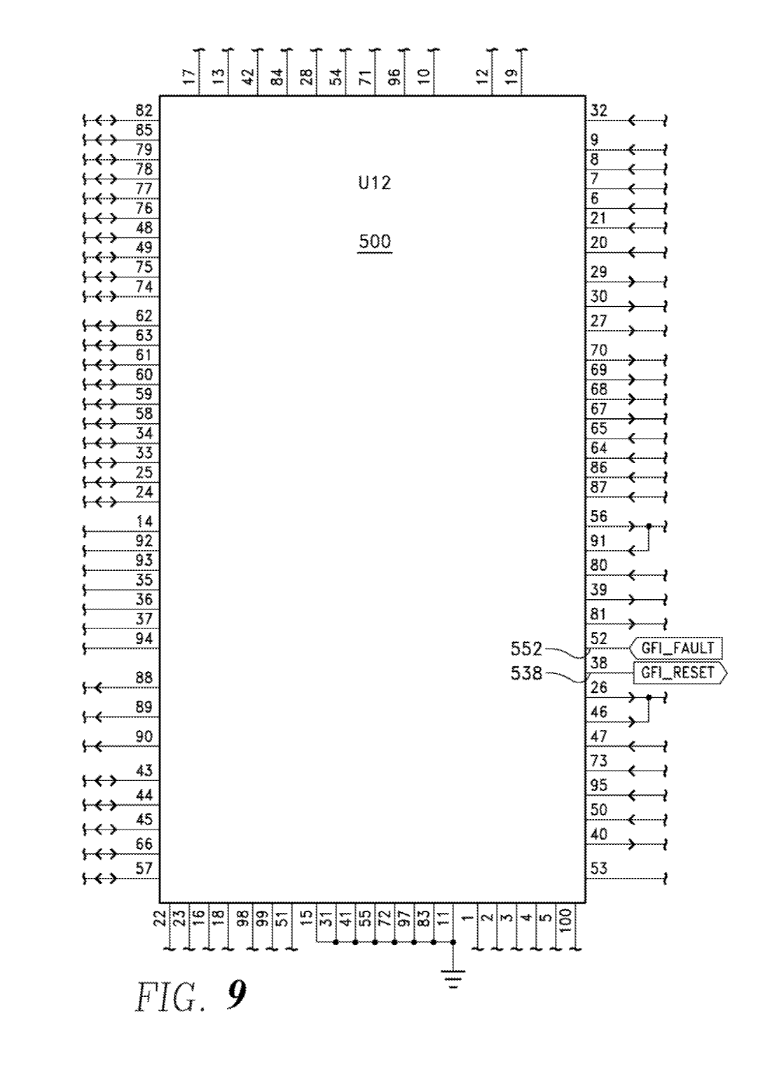

FIG. 9 is a partial schematic showing a microprocessor 500, which may be used to govern the output of the GFI circuit 130 (FIG. 6). Referring to FIGS. 6 and 9, the GFI_FAULT output signal from the fault latch 138 is provided as an input at pin 552 to the microprocessor 500. The microprocessor 500 outputs at pin 538 the GFI_RESET signal to the GFI circuit 130 to control the reset of the GFI circuit 130, in accordance with a predetermined standard, such as UL 2231. This may be accomplished by outputting the GFI_RESET signal to the fault latch 138, and to the CONTACTOR_RESET to the contactor disable latch 152 (FIG. 8).

Also, the microprocessor 500 may also output at pin 81 the GFI_TEST signal, which causes a GFI test circuit 139 to simulate a ground fault for testing the functionality of the contactor 140 (FIG. 5). The GFI test circuit 139 output AC_{—}1 provides a path via pin 2 of the connector 181 to the contactor coil 141 (FIG. 5) to exercise the contactor 140.

Additionally, the microprocessor 500 provides a CONTACTOR_CLOSE signal output to the contactor close circuit to close the contactor control relay K1 (FIG. 7).

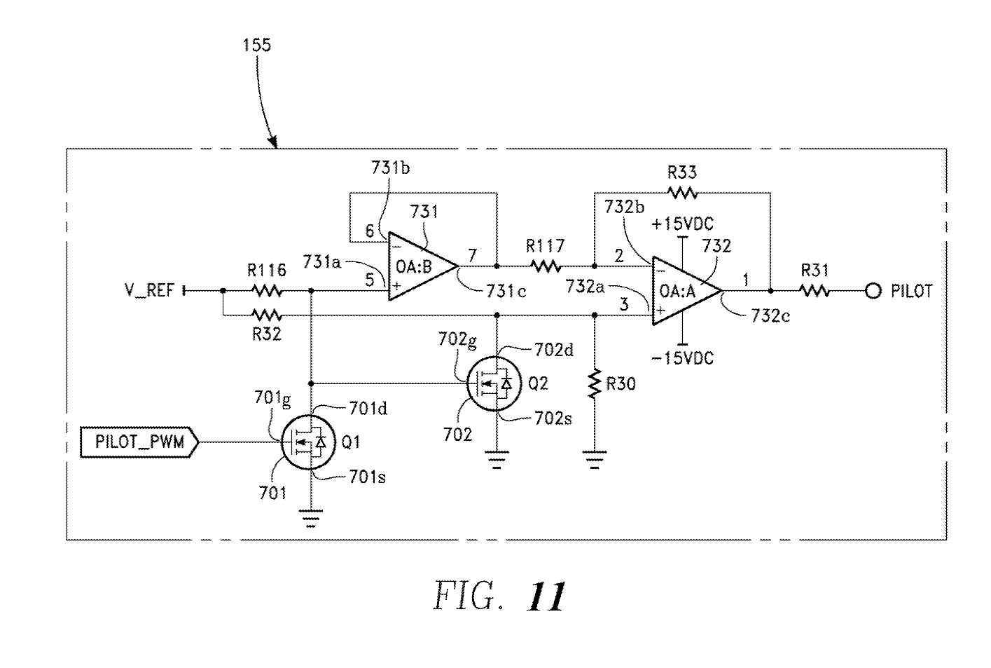

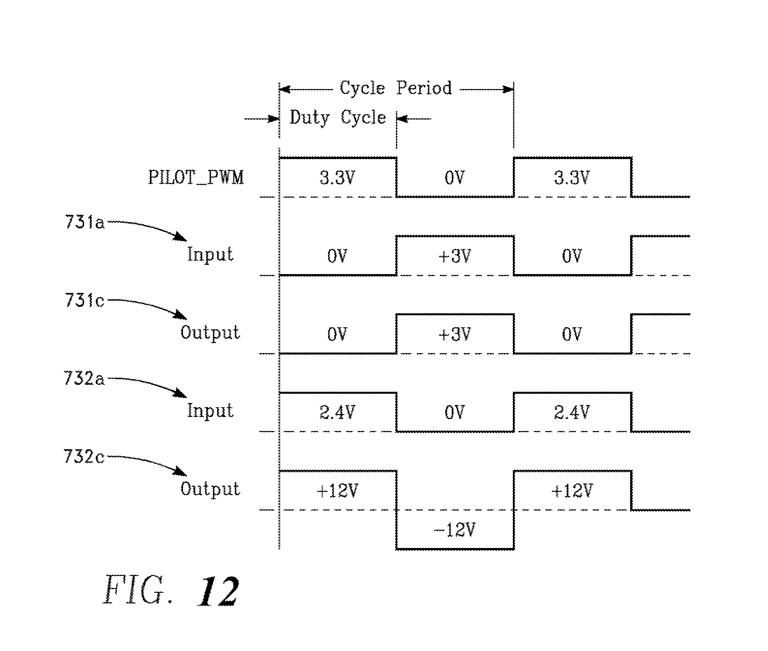

Further, the microprocessor 500 may provide signals to the pilot circuit, such as the PILOT_PWM discussed below with reference to FIGS. 11 and 12.

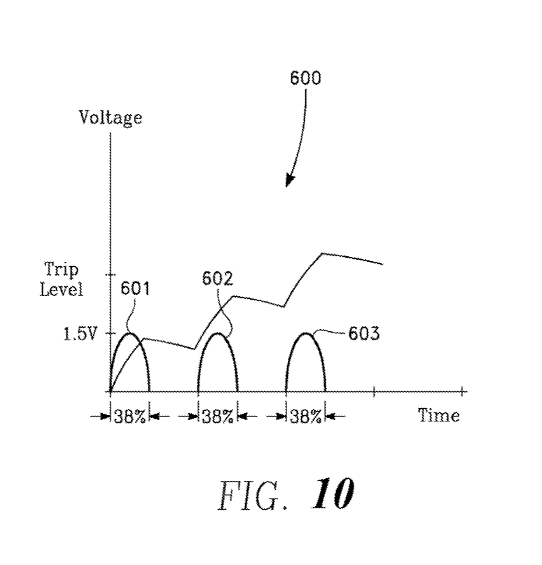

FIG. 10 shows a simplified plot 600 of an example of possible charge accumulation by the double stage filter 134 (FIG. 6) leading to a fault detection by the comparator 136 (FIG. 4). Referring to FIGS. 6 and 10, since the double stage filter 134 discharges slower than it charges, several successive current pulse detections 601, 602, and 603 would be required to cause sufficient charge to accumulate a voltage level that would cause the comparator to indicate a GFI_TRIP. Thus, faults by spurious noise can be minimized. In this simplified example plot, a 1.5 volts pulse of about 38% of the duty cycle for three successive cycles causes sufficient charge to accumulate a GFI_TRIP signal. Other embodiments are possible by appropriate selection of the R102, R103, and C51.

In some embodiments a PILOT signal in accordance with the SAE J-1772 standard is provided. The SAE-J1772 standard, incorporated herein by reference in its entirety, requires precise voltage levels on the PILOT signal, which communicates a charge current command from the electric vehicle supply equipment system, illustrated in FIGS. 5-9, to the electric vehicle. A certain level of error is allowed but more precise signal sourcing provides a more confident operational profile. In various embodiments, the pilot signal generation circuit 150 generates a clean and precise PILOT signal. The pilot signal generation circuit 150 provides the PILOT signal via the connector 100c at the vehicle end of the cable 100. The pilot signal communicates information between the battery charger (not shown) in the vehicle and the electric power supply control system illustrated in FIGS. 5-9.

FIG. 11 is a simplified schematic diagram of a pilot signal generation circuit 155 in accordance with one possible embodiment. FIG. 12 is an example timing diagram of signals for the pilot circuit 155 of FIG. 11. In the embodiment of FIG. 11, the PILOT signal is to be sourced at a value of from +12.0 Volts to −12.0 Volts in a pulse width modulated (PWM) square wave with a frequency of 1,000 Hz. A logic level pulse width modulated square wave PILOT_PWM signal controls the duty cycle and frequency. In the embodiment of FIG. 11 and the timing diagram illustrated in FIG. 12, the PILOT_PWM signal is a logic level signal of 0-3.3 Volts. The logic level signal PILOT_PWM may be any other voltage(s) depending on the embodiment. An absolute reference voltage V_REF provides the precision voltage value for the circuit 155. In this example V_REF is +3.0V. Operational amplifiers 731 and 732, and resistors R30-R32 and R116-R117 are used in conjunction with two Field Effect Transistors or FETs 701 and 702 to generate the final PILOT signal. In this example, the typical resistance values for R30-R32, R116, and R117 are given in ohms as 100K, 1.00K, 25.0K, 10.0K, and 25.0K, respectively, but the values can be altered to change the circuit 155 performance. In other embodiments, the transistors 701 and 702 may be another type, such as bipolar for example.

As shown in FIG. 11, the pilot signal generation circuit 155 has a first operational amplifier 731 having a non-inverting input connected via a first resistor R116 to receive a source reference voltage V_REF. The output 731c is directly connected to the inverting input 731b of the first operational amplifier. A second operational amplifier 732 has its non-inverting input 732a connected via a second resistor R32 to receive the source reference voltage V_REF. The non-inverting input 732a is also connected in parallel to ground or other reference voltage via resistor R30. The inverting input 732b is connected via a resistor R117 to the output 731c of the first operational amplifier. The output 732c connected via a resistor R33 to the non-inverting input 732b of the second operational amplifier 732.

Furthermore, the pilot signal generation circuit 155 has a first transistor 701 with its gate 701g connected to receive a logic level pulse width modulated control signal PILOT_PWM. The logic level pulse width modulated control signal PILOT_PWM may be supplied by the microprocessor 500 (FIG. 9). The drain 701d is connected to the non-inverting input 731a of the first operational amplifier 731, and the source 701s is connected to ground or other reference voltage. A second transistor 702 has a gate 702g connected to the drain 701d of the first transistor 701. The drain 702d of the second transistor 702 is connected to the non-inverting input 732a of the second operational amplifier 732, and the source 702s is connected to ground or other reference voltage.

Referring again to FIGS. 11 and 12, the PILOT_PWM signal may be a digital signal created by an external control source, such as a microprocessor 500 (FIG. 9). The logic level signal PILOT_PWM controls operation of the pilot signal generation circuit 155.

When the PILOT_PWM signal is low at the gate 701g of transistor 701, transistor 701 is open from drain 701d to source 701s. The voltage on transistor drain 701d then feeds into transistor gate 702g causing it to turn on, shorting its drain 702d to source 702s. In this condition, the input 731a of the first operational amplifier 731 has a high impedance +3.00 Volts applied to it, which is then buffered by the second operational amplifier 732 to provide a low impedance signal at +3.00 Volts for the second operational amplifier 732 to use as a signal source. Input 732a of the second operational amplifier 732 is held at 0 Volts by transistor 702. As a result, the output of 732c of the second operational amplifier 732 then has a negative voltage proportional to the gain of the second operational amplifier 732 circuit, specified by the ratio of R33 to R117; in this case, −12.00 Volts.

When the PILOT_PWM signal is high, 701 is shorted from drain 701d to source 701s. The 0 Volts on drain 701d of transistor 701 then feeds into gate 702g of transistor 702 causing it to be open from drain 702d to source 702s. In this condition, input 731a the first operational amplifier 731 has 0 Volts applied to it, which is then buffered by the first operational amplifier 731 to provide 0 Volts for the second operational amplifier 732 to use as a signal source at input 732b. Input 732a of the second operational amplifier 732 is fed by the +3.00 Volts reference V_REF and differentially amplified against the 0 Volts signal provided from output 731c. As a result, the output 732c of the second operational amplifier 732 has a positive voltage proportional to the gain of the second operational amplifier 732 circuit, specified by R33, R117, R30 and R32; in this case, +12.00 Volts.

Thus, by use of this circuit 155, a high or low logic level signal PILOT_PWM of imprecise voltage will provide a precise +12 Volt to −12 Volt square wave output suitable for use as the control communication signal source PILOT for the SAE-J1772 standard signal generation. Accuracy is only limited by component selection. Because this circuit 155 is absolute reference and amplifier regulated, the +/−12 volt signals are extremely accurate with no undesired component losses. This supports and enhances the application of the SAE J-1772 standard for reading the communication level control voltages without errors.

If the onboard charger sees a signal amplitude too low or too high, or improper frequency or pulse width within an expected range, it will shut off because it will assume that the integrity of the connection is bad. So it is important to have a precise PILOT signal.

In various embodiments of the pilot signal generation circuit 155, the operational amplifier 731 is configured to buffer the input 731a to the output 731c. The operational amplifier 732 is configured with resistors R30, R32, R33, and R117 as a differential amplifier. The transistor 701 is connected to the operational amplifier 731 to shunt the source reference voltage V_REF at the input 731a of the operational amplifier 731. The transistor 702 is connected to the operational amplifier 732 to shunt the source reference voltage V_REF at the input 732a of the operational amplifier 732 in response to a voltage level at the input 731a of the operation amplifier 731.

Thus, the pilot signal generation circuit 155 is configured to receive a logic level pulse width modulated signal PILOT_PWM at the input 701g of the transistor 701 and to provide a pulse width modulated bipolar signal PILOT at precision voltage levels at the output 732C of the second operational amplifier 732.

In various embodiments, the pilot generation circuit 155 is able to provide an output PILOT signal with precise voltage levels to within about 1% at +/−12 Volts.

The voltage of the PILOT signal will indicate the status of the connection between the cable 100 and the vehicle (not shown). In this example, a PILOT signal of +12 Volts indicates that the connector 100c is disconnected from the vehicle and not stowed. Optionally, a PILOT signal voltage of +11 Volts may be used to indicate that the connector 110c is stowed, at a charging station, for example. A PILOT signal voltage of +9 Volts indicates that the vehicle is connected. A PILOT signal voltage of +6 Volts indicates that the vehicle is charging without ventilation. A PILOT signal voltage of +3 Volts indicates that the vehicle is charging without ventilation. A PILOT signal voltage of 0 Volts indicates that there is a short or other fault. A PILOT signal voltage of −12 Volts indicates that there is an error onboard the vehicle.

A pilot detection circuit 157 within the pilot circuit 150 detects the voltages, generates, and provides a PILOT_DIGITAL signal to the microprocessor 500 (FIG. 9). The pilot detection circuit 157 also generates and provides a PILOT_MISSING_FAULT signal to the microprocessor 500 (FIG. 9). In response, the microprocessor 500 controls the connection of the utility power L1 and L2. For example, the microprocessor 500 can set the CONTACTOR CLOSE signal, discussed above, to cause the control contactor 170 to open the contactor 140 if a PILOT_MISSING_FAULT is detected.

It is worthy to note that any reference to “one embodiment” or “an embodiment” means that a particular feature, structure, or characteristic described in connection with the embodiment may be included in an embodiment, if desired. The appearances of the phrase “in one embodiment” in various places in the specification are not necessarily all referring to the same embodiment.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated.

Those skilled in the art will make modifications to the invention for particular applications of the invention.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

Having described this invention in connection with a number of embodiments, modification will now certainly suggest itself to those skilled in the art. The example embodiments herein are not intended to be limiting, various configurations and combinations of features are possible. As such, the invention is not limited to the disclosed embodiments, except as required by the appended claims.

What is claimed is:

1. In an electric vehicle supply equipment comprising a pilot signal, a method for reducing noise on a pilot signal output to determine a value of the pilot signal output to an electric vehicle, the method comprising:
a) sampling the pilot signal and creating a first data set comprising samples of the pilot signal;
b) selecting a first subset from the first data set;
c) averaging the samples of the first subset to produce a first tier average;
d) repeating the sampling, the selecting, and the averaging to create a second data set comprising a plurality of the first tier averages;
e) selecting a second subset from the second data set;
f) averaging the first tier averages in the second subset to provide a second tier average; and
g) generating a signal based on the second tier average to indicate a detected value of the pilot signal.

2. The method of claim 1, wherein selecting the first subset from the first data set comprises omitting two of the samples with highest values in the first data set and two of the samples with lowest values in the first data set.

3. The method of claim 2, wherein selecting the second subset from the second data set comprises omitting two of the first tier averages with highest values in the second data set and two of the first tier averages with the lowest values in the second data set.

4. The method of claim 1, wherein creating the first data set comprises storing values of the samples in memory.

5. The method of claim 4, wherein creating the second data set comprises storing values of the plurality of the first tier averages in memory.

6. The method of claim 1, further comprising generating the pilot signal with a modulation rate within an allowable range and offset from a central modulation rate of the allowable range.

7. The method of claim 6, wherein generating the pilot signal comprises generating the pilot signal having a modulation rate offset about 10% to 15% of the central modulation rate away from the central modulation rate.

8. The method of claim 6, wherein generating the pilot signal comprises generating the pilot signal having a modulation rate of about 1015 Hz.

9. The method of claim 6, wherein generating the pilot signal comprises generating the pilot signal having a modulation rate of about 985 Hz.

10. The method of claim 1 further comprising using the second tier average in controlling power distribution at an output of the electric vehicle supply equipment.

11. In an electric vehicle supply equipment comprising a generated pilot signal, a method for reducing induced noise in a pilot signal output to an electric vehicle, the method comprising generating the pilot signal with a modulation rate within an allowable range and offset from a central modulation of the allowable range.

12. The method of claim 11, wherein generating the pilot signal comprises generating the pilot signal having a modulation rate offset about 10% to 15% of the central modulation rate away from the central modulation rate.

13. The method of claim 11, wherein generating the pilot signal comprises generating the pilot signal having a modulation rate of about 1015 Hz.

14. The method of claim 11, wherein generating the pilot signal comprises generating the pilot signal having a modulation rate of about 985 Hz.

15. The method of claim 11, further comprising determining a value of the pilot signal and controlling power distribution at an output of the electric vehicle supply equipment based on the value.

16. An electric vehicle supply equipment comprising a pilot signal circuit for generating a pilot signal, the electric vehicle supply equipment comprising:
a) a pilot signal sampler for generating samples of the pilot signal;
b) a power delivery output; and
c) a processor programmed to determine a signal level of the pilot signal output based on the samples, the processor comprising processor executable instructions for carrying out the steps comprising:
i) trimming a first data set of pilot signal samples and generating an average from the trimmed samples of the first data set;
ii) generating a second data set from a plurality of first data sets by repeating the trimming and generating the average from the trimmed samples of the first data set;
iii) trimming the second data set and generating an average from the trimmed samples of the second data set; and
iv) using the average of the trimmed second data set in controlling power delivery at the power delivery output of the electric vehicle supply equipment.

17. The apparatus of claim 16, wherein the processor comprises the processor executable instructions for carrying out the steps comprises the trimming of the first data set by omitting two of the samples of the pilot signal with highest values in the first data set and two of the samples with lowest values in the first data set.

18. The apparatus of claim 17, wherein the processor comprises the processor executable instructions for carrying out the steps comprises the trimming of the second data set by omitting two of the samples of the second data set with highest values in the first data set and two of the samples with lowest values in the second data set.

19. The apparatus of claim 16, further comprising a pilot signal circuit adapted to generate a pilot signal with a modulation rate within an allowable range and offset from a central modulation rate of the allowable range.

20. The apparatus of claim 19, wherein pilot signal circuit is adapted to generate the pilot signal having a modulation rate offset about 10% to 15% of the central modulation rate away from the central modulation rate.

21. The apparatus of claim 19, wherein pilot signal circuit is adapted to generate the pilot signal having a modulation rate of about 1015 Hz.

22. The apparatus of claim 19, wherein pilot signal circuit is adapted to generate the pilot signal having a modulation rate of about 985 Hz.

23. The apparatus of claim 16, further comprising a storage medium, and wherein the processor comprises the processor executable instructions for carrying out the steps further comprising:
a) storing samples of the pilot signal in the first data set to readable storage medium; and
b) storing the second data to the storage medium.
